(19) United States
(12) Patent Application Publication
(10) Pub. No.: US 2019/0250722 A1
(43) Pub. Date: Aug. 15, 2019

(54) MULTI-SENSING TRIGGER FOR HAND-HELD DEVICE

(71) Applicant: MUV INTERACTIVE LTD., Herzliya Pituach (IL)

(72) Inventors: Rami PARHAM, Beer Yaakov (IL); Eyal BOUMGARTEN, Kiryat Ono (IL); Hanan KRASNOSHTEIN, Ramat Gan (IL); Menashe SASSON, Bat Hefer (IL)

(21) Appl. No.: 16/336,471

(22) PCT Filed: Sep. 25, 2017
(86) PCT No.: PCT/IL2017/051074

§ 371 Date: Mar. 26, 2019

Related U.S. Application Data
(60) Provisional application No. 62/399,522, filed on Sep. 26, 2016.

(51) Int. Cl. G06F 3/0338; G06F 3/03; G06F 3/01; G06F 3/0346; G06F 3/0354; G06F 3/038

(52) U.S. Cl. CPC G06F 3/0338; G06F 3/0304; G06F 3/014; G06F 3/0346; G06F 2203/0384; G06F 3/0386; G06F 3/017; G06F 2203/0331; G06F 3/03547

(57) ABSTRACT

A multi-sensory finger-wearable pointing device, comprising: at least one emitter; a multi-sensory interface, comprising: a proximity sensor, and a pressure sensitive mechanism configured to sense a first pressure and a second pressure; and a processor configured to: responsive to receiving an indication from any of: the proximity sensor, and the pressure sensitive mechanism that the first pressure was sensed, trigger a tracking of a position of a moving target pointed at by the pointing device, wherein the tracking is based on tracking information emitted by the at least one emitter, and responsive to receiving an indication from the pressure sensitive mechanism that the second pressure was sensed, trigger a location based action corresponding to the tracked position of the moving target.

### CROSS-REFERENCE TO RELATED APPLICATIONS

This application claims priority to U.S. Provisional Patent Application No. 62/399,522, filed Sep. 26, 2016, entitled “Multi-Sensing Trigger for Hand-Held Device”, the contents of which are incorporated herein by reference.

### BACKGROUND

The invention relates to the field of position detection systems.

Optical pointing devices have become increasingly popular with the advancement of wireless and mobile technology. Such devices allow users to remotely control the operation of one or more applications and/or additional devices by directly indicating a target using the optical pointer. One popular application for optical pointing devices is to remotely control the display of visual content. The user may wirelessly interact with visual content displayed on a screen by directly pointing to a target on the screen. Some screens have optic sensors embedded therein, allowing them to self-detect the target indicated by the optical pointer. Other implementations allow the projection of the visual content onto a generic surface, such as a wall, ceiling, or table top. In this case, a camera is positioned to track the target indicated by the optical pointer.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a multi-sensory finger-wearable pointing device, comprising: at least one emitter; a multi-sensory interface, comprising: a proximity sensor, and a pressure sensitive mechanism configured to sense a first pressure and a second pressure; and a processor configured to: responsive to receiving an indication from any of: the proximity sensor, and the pressure sensitive mechanism that the first pressure was sensed, trigger a tracking of a position of a moving target indicated by the pointing device, wherein the tracking is based on tracking information emitted by the at least one emitter, and responsive to receiving an indication from the pressure sensitive mechanism that the second pressure was sensed, trigger a location based action corresponding to the tracked position of the moving target.

In some embodiments, the at least one emitter comprises a radio-frequency (RF) emitter, wherein triggering the tracking comprises emitting a tracking notification via the RF emitter and wherein triggering the location based action comprises emitting an action notification via the RF emitter.

In some embodiments, the RF transmitter is further configured to transmit the tracking information, wherein the tracking information comprises motion and orientation data of the device.

In some embodiments, the at least one emitter comprises at least one optical emitter configured to emit an optical beam indicating the moving target, wherein the tracking information comprises the optical beam.

In some embodiments, the at least one optical emitter comprises a longitudinal optical emitter aligned along a longitudinal axis of the device such that the optical beam emitted by the longitudinal optical emitter is substantially parallel to the longitudinal axis when the indication is received by the proximity sensor.

In some embodiments, the at least one optical emitter comprises a surface optical emitter positioned on a surface of the device, when the indication that the first pressure was sensed is received from the pressure sensitive mechanism.

In some embodiments, the proximity sensor is selected from the group consisting of: a capacitive sensor, an optical sensor, a resistive sensor, and a magnetic sensor.

In some embodiments, the proximity sensor is operative to implement a slider action.

In some embodiments, the second pressure level is greater than the first level.

In some embodiments, triggering the position tracking of the moving target responsive to receiving the indication from the proximity sensor initiates a remote mode of use for the device, and wherein triggering the position tracking of the moving target responsive to receiving the indication from the pressure sensitive mechanism that the first pressure was sensed initiates a contact mode of use for the device.

In some embodiments, the moving target is implemented as a cursor for controlling an application.

In some embodiments, the location-based action is a click action for the cursor.

In some embodiments, the finger-wearable pointing device further comprises a radio frequency (RF) receiver configured to receive a control signal, wherein the processor is configured to use the control signal to control the finger-wearable indicator.

There is provided, in accordance with an embodiment, a system comprising: a multi-sensory finger-wearable pointing device, comprising: at least one emitter, a multi-sensory interface, comprising: a proximity sensor, and a pressure sensitive mechanism configured to sense a first pressure and second pressure, and a processor configured to: responsive to receiving an indication from any of: the proximity sensor, and the pressure sensitive mechanism that the first pressure was sensed: trigger a tracking of a position of a moving target indicated by the pointing device by transmitting a tracking notification via the at least one emitter, wherein the tracking is based on tracking information emitted by the at least one emitter, and responsive to receiving an indication from the pressure sensitive mechanism that the second pressure was sensed, trigger a location based action corresponding to the tracked position of the moving target by transmitting an action notification via the at least one emitter; a controller; and at least one receiver, wherein the controller is configured to, responsive to receiving the tracking notification via the at least one receiver, track the target using the tracking information received via the at least the receiver, and responsive to receiving the action notification, execute the location based action.

In some embodiments, the at least one emitter comprises a radio-frequency (RF) emitter configured to transmit each of the tracking notification and the action notification comprise as an RF signal, and wherein the at least one receiver comprises an RF receiver.

In some embodiments, the RF emitter is configured to transmit the tracking information comprising motion and orientation data as an RF signal.

In some embodiments, the at least one emitter comprises at least one optical emitter configured to emit an optical beam indicating the moving target, wherein the tracking information comprises the optical beam.

In some embodiments, the at least one optical emitter comprises a longitudinal optical emitter aligned along a longitudinal axis of the finger-wearable pointing device such that the optical beam emitted by the longitudinal optical emitter is substantially parallel to the longitudinal axis when the indication is received by the proximity sensor.

In some embodiments, the at least one optical emitter comprises a surface optical emitter positioned on a surface of the device, when the indication that the first pressure was sensed is received from the pressure sensitive mechanism.

In some embodiments, the proximity sensor is selected from the group consisting of: a capacitive sensor, an optical sensor, a resistive sensor, and a magnetic sensor.

In some embodiments, the proximity sensor is operative to implement a slider action.

In some embodiments, the second pressure level is greater than the first level.

In some embodiments, triggering the position tracking of the moving target responsive to receiving the indication from the proximity sensor initiates a remote mode of use for the device, and wherein triggering the position tracking of the moving target responsive to receiving the indication from the pressure sensitive mechanism that the first pressure was sensed initiates a contact mode of use for the device.

In some embodiments, the moving target is implemented as a cursor for controlling an application.

In some embodiments, the location based action is a click action for the cursor.

In some embodiments, the system further comprises a radio frequency (RF) receiver configured to receive a control signal from the controller, wherein the processor is configured to use the control signal to control the finger-wearable indicator.

There is provided, in accordance with an embodiment, a multi-sensory finger-wearable pointing device, comprising: at least one emitter; a multi-sensory interface, comprising: a proximity sensor, and a pressure sensitive mechanism configured to sense a pressure; and a processor configured to: responsive to receiving an indication from the proximity sensor, trigger a tracking of a position of a moving target indicated by the pointing device, wherein the tracking is based on tracking information emitted by the at least one emitter, and responsive to receiving an indication from the pressure sensitive mechanism that the pressure was sensed, trigger a location based action corresponding to the tracked position of the moving target.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIGS. 1A-1E show different views of a hand-held optical indicating device, in accordance with an embodiment;

FIGS. 1F-1G show a side and perspective view, respectively, of a push-button mechanism implemented on a glider base of the hand-held optical indicating device of FIGS. 1A-1E; and

FIG. 2A shows a system for optically tracking a target indicated by hand held device in a first mode of use;

FIG. 2B shows a system for optically tracking a target indicated by hand held device in a second mode of use;

FIG. 2C shows another system for optically tracking a target indicated by hand held device;

FIG. 3 shows a block diagram of hand held optical indicating device; and

FIG. 4 shows a flowchart of a method for using hand held optical indicating device.

### DETAILED DESCRIPTION

A finger-wearable pointing device is disclosed for indicating a moving target on a screen or surface. The position of the moving target may be tracked by a control unit coupled with a camera and/or an RF receiver to allow a user to use the finger-wearable device to interact with visual content projected on the screen. Tracking may be actively initiated via two modes of use: touching or almost touching a proximity sensor of the device may trigger the tracking for a remote use mode, and pressing a pressure-sensitive mechanism of the device against a surface may trigger the tracking for a contact use mode. The pressure-sensitive mechanism and the proximity sensor may be integrated on the same multi-sensory interface of the device, allowing the user to conveniently select the mode of use. The proximity sensor may be positioned to be within convenient range of the user's thumb when the device worn on the user's finger, such as the index finger. The pressure-sensitive mechanism may be positioned on a plane facing the user's fingertip when the device is worn on the user's finger, and thus may be pressed either by pinching the pressure-sensitive mechanism between the thumb and finger for the remote mode of use, or by pointing with the finger onto the surface, and pressing the pressure-sensitive mechanism between the finger and the surface for the contact mode of use.

In one embodiment, the finger-wearable device may operate as an electronic mouse. Once activated, the target illuminated by the device's optical pointer is tracked as a conventional cursor. The device may include additional user interface features, such as buttons, sliders and the like, that allow implementing additional electronic mouse functionalities, such as clicking, dragging, and selecting, to name a few.

The term ‘emitter’ as used herein is understood to include any suitable emitter of signals, such as but not limited to an optical signal emitter such as a light source, a radio frequency (RF) signal transmitter, and the like.

The term ‘receiver’ as used herein is understood to include any suitable receiver of signals, such as but not limited to an optical signal receiver such as a camera, a RF signal receiver, and the like.

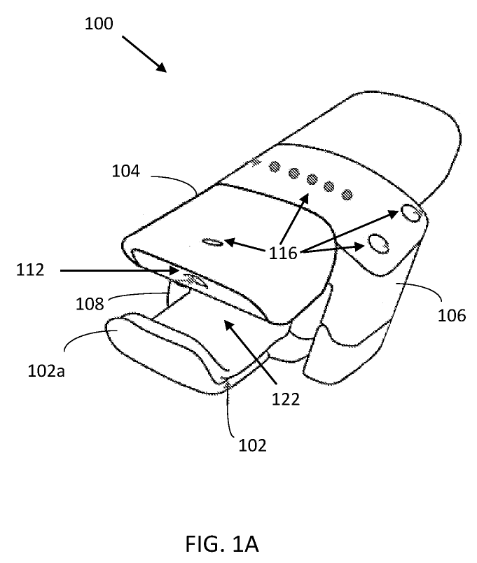

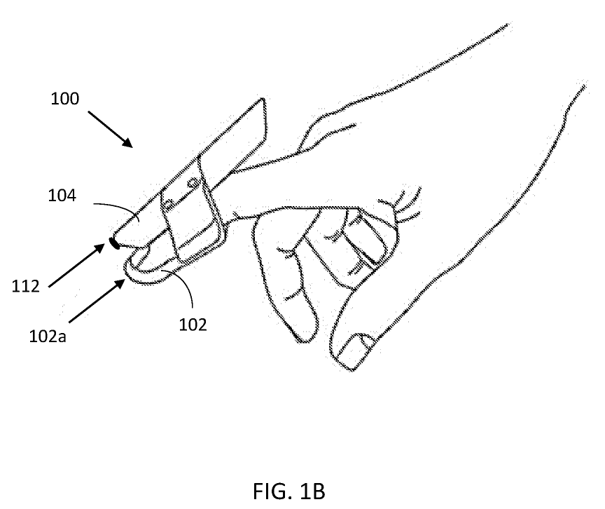

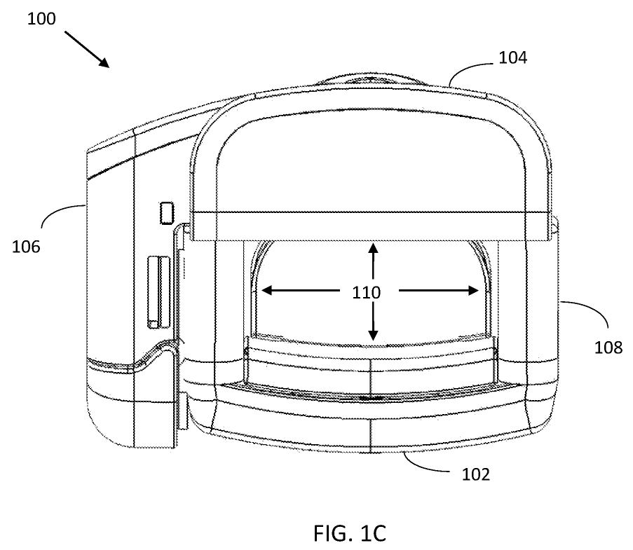

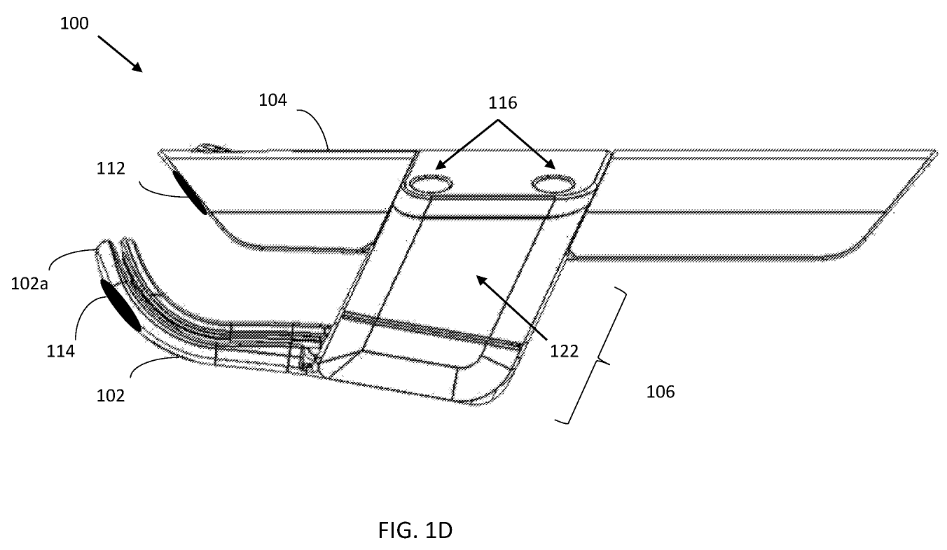

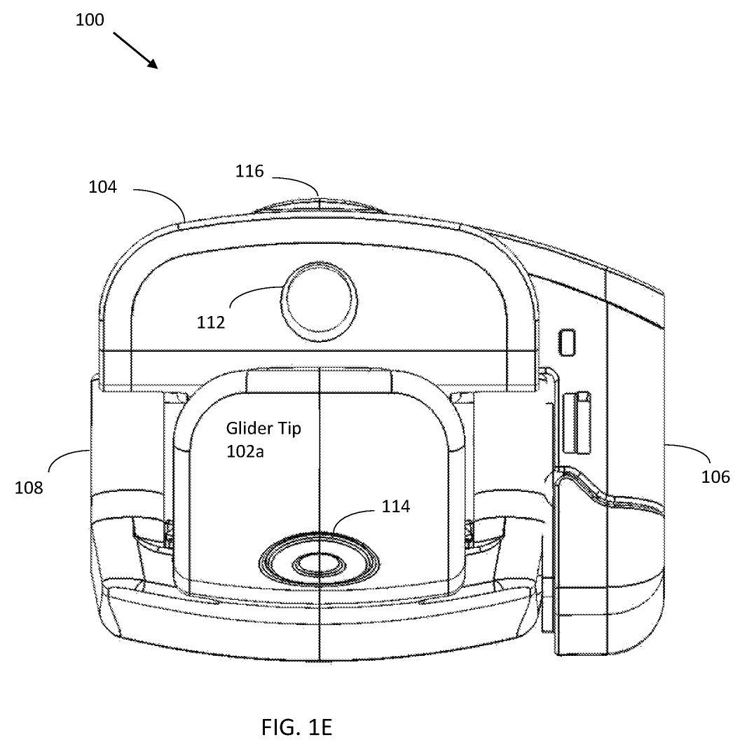

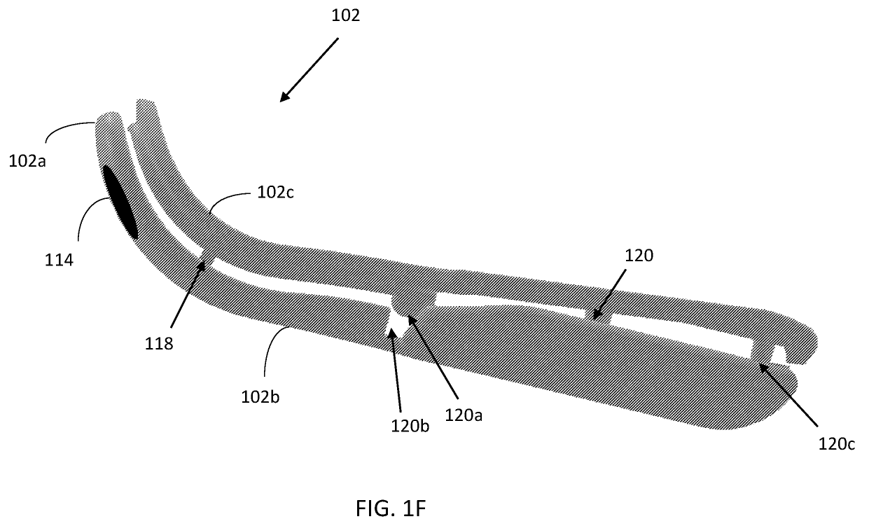

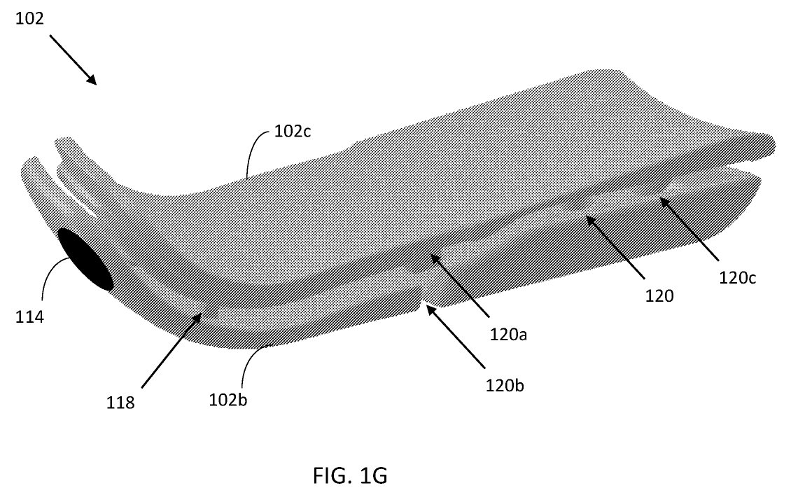

Reference is now made to FIG. 1A, which illustrates perspective view of a hand-held indicating device 100. Device 100 is provided with a bottom ‘glider’ plate 102, a top bar 104, and a side control bridge 106 that, together with a side support bridge 108, connects glider 102 to bar 104. The space between glider 102 and bar 104 may be suitable for securing a finger of a user.

Device 100 may include an optical emitter 112, such as a laser light source or light emitting diode (LED). Emitter 112 may be aligned along a longitudinal axis of device 100 such that the optical beam emitted by emitter 112 is substantially parallel to the longitudinal axis. Thus, when device 100 is worn on the user's finger, the emitted light beam is oriented substantially in the direction of the user's finger, allowing him to indicate a target on a screen or surface by pointing as one would naturally point with one's hand. As the user moves device 100 such as by moving his hand or finger, the longitudinally aligned optical beam moves accordingly, moving the target. The user may trigger one or more remote functionalities for an application using hand gestures such as by pinching and/or pressing his fingers, rotating his hand, pressing one or more control buttons of device 100, and the like. The optical beam emitted by the longitudinally aligned emitter 112 may be used to track the indicated moving target for the remote use mode.

One or more additional optical emitters 116 may be provided on the surface of top bar 104 for spatially tracking device 100 for the contact or touch mode, and/or for indicating one or more indications to the user. Emitters 116 may be visible by a camera when the user's finger is pressed against a surface, blocking the line of site of the optical beam emitted by emitter 112. Emitters 116 may any combination of laser light sources and LEDs, and may emit light in any of the visible, near infrared (IR), or IR range.

Device 100 may additionally include and a motion and orientation sensor (not shown), such as a multiple-axis motion tracking component. For example, sensor may include any of an accelerometer, a gyroscope, and a compass integrated within a single electronic component, such as the MPU-9250 9-axis motion tracking device or MPU-6500 6-axis motion tracking device by InvenSense, Inc. of San Jose, Calif. Device 100 may transmit motion and orientation data sensed by the sensor via a radio frequency (RF) signal emitter.

Reference is now made to FIGS. 1B-1C which show a perspective view and a proximal view of device 100, respectively. The user may slide his finger into an opening 110 at the proximal end of device 100 and positioned his finger sandwiched between top bar 104 and bottom glider 102, and enclosed on the sides by control bridge 106 and support bridge 108 such that his fingertip rests on the upper surface of bottom glider 102 at the distal end of device 100. The fingertip may be secured by an upturned lip 102a of glider 102. The distance between the distal tip of lip 102a and the base of glider 102 may range between 2 mm (millimeters) and 10 mm ± 10%. Glider 102 may be at a slight incline, such as by forming an angle of 5°, 10°, 15°, 20°, 25°, or 30° ± 10% with respect to top bar 104 such that proximal opening 110 is slightly larger than a distal opening 122 shown in FIG. 1A, allowing the user to easily slip his finger through device 100 from the proximal end 110 and have his finger secured by glider 102.

Referring to FIGS. 1D-1E, the control side view and distal view of device 100 are shown. Glider 102 may be a multi-sensory interface that is both touch-sensitive and pressure-sensitive. Glider 102 may be disposed at the distal tip with a proximity sensor 114 which may be located to be in easy reach of the user's thumb when device 100 is worn on any of the user's fingers. Proximity sensor 114 may include one or more sensors arranged in an array, allowing different regions of sensor 114 to be sensed. Proximity sensor 114 may comprise any suitable sensor capable of sensing the proximity and/or touch of the user's finger, and may be implemented using any combination of a capacitive, inductive, photoelectric, resistive, optical, or magnetic sensor. By being sensitive to the user's touch, or almost touch, proximity sensor 114 may allow distinguishing between two modes of use for device 100: touching or almost touching sensor 114 with the user's thumb may activate tracking for the remote use mode based on the moving target indicated by the optical beam emitted by longitudinally aligned emitter 112, whereas pressing device 100 against a surface that does not trigger sensor 114 may activate tracking for the contact/touch use mode based on the optical beam emitted by emitter 116 disposed on the surface of top bar 104 and in line-of-site of an optical detector positioned facing the surface. Optionally, the optical beam emitted by emitters 112 and 116 are substantially similarly, such that the image processing required to implement the optical tracking is substantially the same for both modes of use.

Referring to FIGS. 1F-1G, a side view and perspective view of glider 102 are shown, respectively. Glider 102 may include one or pressure sensitive mechanisms 118 implemented via two parallel plates 102b and 102c connected proximally by a normally open hinge-spring 120. When in the normally open state, hinge-spring 120 may maintain a gap between plates 102b and 102c, such as may range between 0.25 millimeters (mm) and 2.5 mm ± 10%. Applying pressure to any of plates 102b and 102c may close, or reduce the gap triggering one or more sensors (not shown) positioned within the gap. Thus, the pressure sensitive mechanism(s) 118 implemented by plates 102b and 102c and hinge 120 may sense different pressures: either applied to different regions of 102b and 102c and/or at different pressure levels. Each applied pressure may correspond to a different functionality of device 100. Optionally, pressure sensitive mechanisms 118 may be a continuous, analog pressure sensor, capable of sensing varying pressure levels. Optionally, pressure sensitive mechanism 118 may be a digital sensor capable of sensing varying pressure levels within a predefined resolution.

Glider 102 may be disposed with a movement restriction rib 120a configured to fit within a niche 120b, and one or more supporting ribs 120c.

In one implementation, the pressure sensitive mechanism may be a single mechanism that is sensitive to varying levels of pressure, allowing the same mechanism to be used for different functionalities. Pressure sensitive mechanism 118 may be implemented as a button protruding from the gap side of any one of plates 102b and 102c paired with an oppositely facing indentation disposed on the gap side of the other one of plates 102b and 102c. When hinge-spring 120 is normally open, the button does not engage with indentation. When a light tap is applied to glider 102 causing hinge-spring 120 to partially close, the button partially engages with the indentation triggering a first sensor (not shown) to send out an indication, such as to trigger tracking for the contact or touch mode of use. When a greater pressure is applied to glider 102, the button may further engage with the indentation triggering a second sensor (not shown) to send out a second indication, such as to activate a location based functionality.

Alternatively, instead of two pressure levels implemented on the same button mechanism, glider 102 may be may be provided with multiple button mechanisms each corresponding to a different functionality, and each triggered by applying pressure to a different region of glider 102. Any of plates 102b and 102c may be provided with one or more sensors coupled to an oppositely facing button-indention pair 118 disposed at different regions on the gaps sides of plates 102b and 102c. On sensing the engagement of any of a button-indention pair, the coupled sensor may send out an indication. Alternatively, each protruding button on one of plates 102b and 102c may be coupled directed with a sensor disposed on the gap side of the opposite one of plates 102b and 102c, precluding the need for an indentation. On sensing contact with a button, the sensor may send out an indication.

Alternatively, the pressure sensitive mechanism(s) may be implementing by positioning one or more opposite facing pairs of sensors (not shown), such as electrode pairs, at different regions on the gap sides of plates 102b and 102c such that pressing plates 102b and 102c together closes or partially closes the gap, causing each sensor pair to send out an indication. The sensor pairs may be a combination of proximity sensors and/or full-contact sensors. Thus, applying pressure to the different regions and/or at different pressure levels may trigger different sensor pairs each sending out a different indication. For example, a light tap may trigger a proximity sensor pair to emit a first indication, and applying greater pressure may trigger a full-contact sensor pair to emit a second indication.

It may be noted that the implementations described above are not meant to be limiting, and any suitable technique to achieve sensitivity to different pressures applied to glider 102 may be used.

A processor (not shown) integrated within device 100 may receive the indications from proximity sensor 114 and each of the different pressures sensed by the pressure sensitive mechanism(s) 118 and use the indications to trigger different functionalities and/or actions, as follows:

Responsive to receiving an indication from proximity sensor 114 or receiving an indication from pressure sensitive mechanism 118 sensing that the first pressure was sensed, the processor may trigger the tracking of the position of the moving target indicated by device 100 by emitting a tracking notification via the RF transmitter. The tracking may be based on tracking information emitted by device 100. As noted above, receiving the indication from proximity sensor 114 triggers tracking for the remote use mode, and receiving the indication from pressure sensitive mechanism 118 triggers the tracking for the contact/touch use mode.

The tracking may be optically based. In this case, the optical beam emitted by one of emitters 112 and 116 indicates the moving target, and the tracking information emitted by device 100 comprises the emitted optical beam. When the tracking is triggered via proximity sensor 114, the optical beam emitted by longitudinal emitter 112 configured for the remote use mode is used to track the moving target, and comprises the tracking information. When the tracking is triggered via pressure sensing mechanism 118, the optical beam emitted by surface emitter 116 configured for the contact/touch use mode is used to track the moving target, and comprises the tracking information.

For example, when proximity sensor 114 detects the proximity of the user's thumb, such as when the user wears device 100 on his finger, and brings his thumb to the finger in a pinching motion to touch or almost touch sensor 114, the processor may activate device 100 to operate as a remote pointing device, and may trigger the tracking of the position of the moving target indicated by longitudinally aligned emitter 112.

Alternatively, when pressure sensitive mechanism 118 of device 100 is tapped lightly against a stiff and/or cold surface that does not activate proximity sensor 114, the processor may activate device 100 to operate as a touch pointing device, and may trigger the tracking of the position of the moving target indicated by surface-positioned emitter 116.

Additionally, or alternatively the tracking may be based on inertial data, such as motion and orientation data of device 100 sensed by the motion and orientation sensor. In this case, the tracking information comprising the motion and orientation data may be transmitted via the RF transmitter.

Once the tracking has been initiated via any of the above mechanisms, responsive to receiving an indication from pressure sensitive mechanism 118 that the second pressure level was sensed, the processor may trigger a location based action corresponding to the tracked position of the moving target by emitting an action notification via the RF transmitter.

The second pressure level may be approximately 275 g to 325 g, or 250 g to 350 g, or 225 to 375 g, or 200 g to 400 g and may be exerted on pressure sensitive mechanism(s) 118 by either pinching glider 102 firmly between the thumb and forefinger, or by pressing the base of glider 102 firmly against the surface. Alternatively, the first and second pressures may be applied by pressing different regions of pressure sensitive mechanism(s) 118.

The second functionality may trigger a location-based action of the target, such a mouse click action that controls the display of graphic content associated with the application, allowing the user to select, move, and/or rotate the graphic content, and/or open and/or close an application associated with the graphic content.

In one implementation, the target may be implemented as a cursor, and the location-based operation may be a click, select, open, or close action by the cursor action to control the display of displayed graphic content, including any of selecting, moving, and/or rotating the graphic content, and/or opening and/or closing an application associated with the graphic content.

Optionally, once the cursor is activated as described above, proximity sensor 114 may be operative to activate a slider to scroll through a displayed document. Additionally, or alternatively, sensor 114 may be used to implement zoom-in and/or zoom-out functions for the displayed graphic content. As the user swipes his thumb over the multiple individual sensors comprising sensor 114, the individual sensors may independently sense the thumb and transmit their relative position to processor, which may use the relative positions to control the scrolling, zooming-in and zooming-out accordingly. Additionally, one or more action buttons 122 disposed on control bridge 106 and shown in FIG. 1D, may be used to activate additional functionalities.

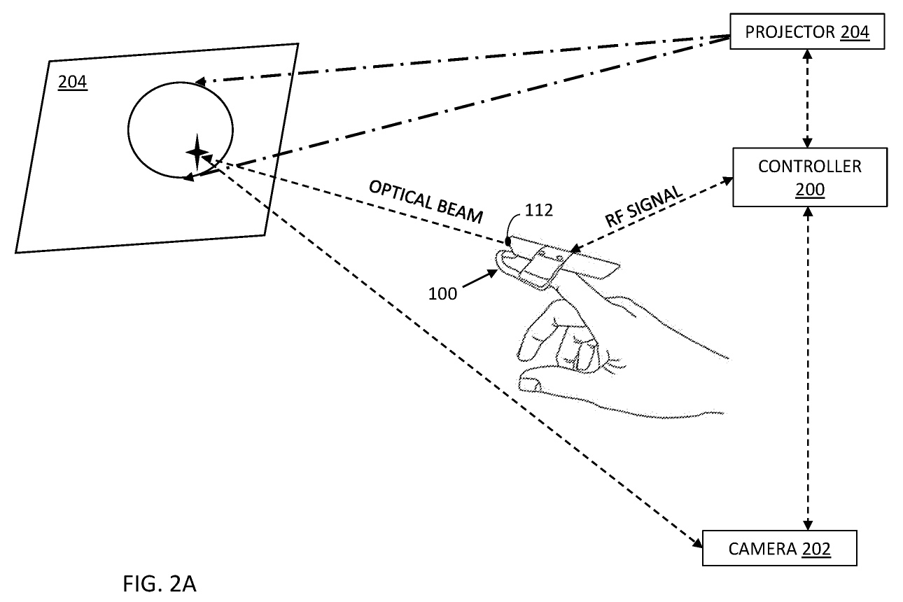

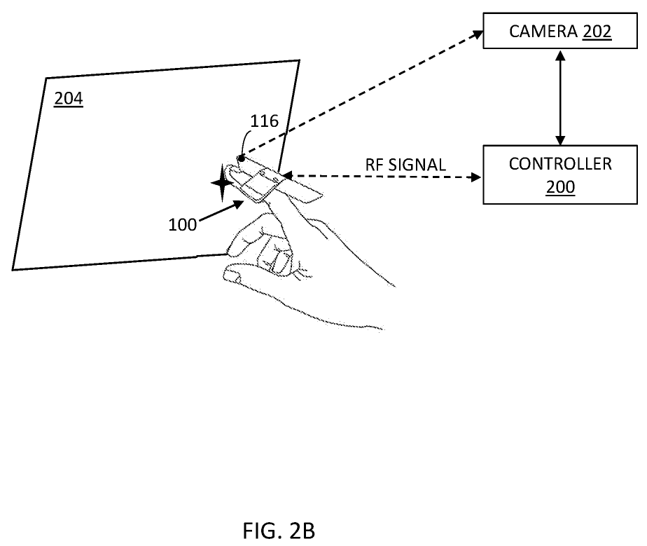

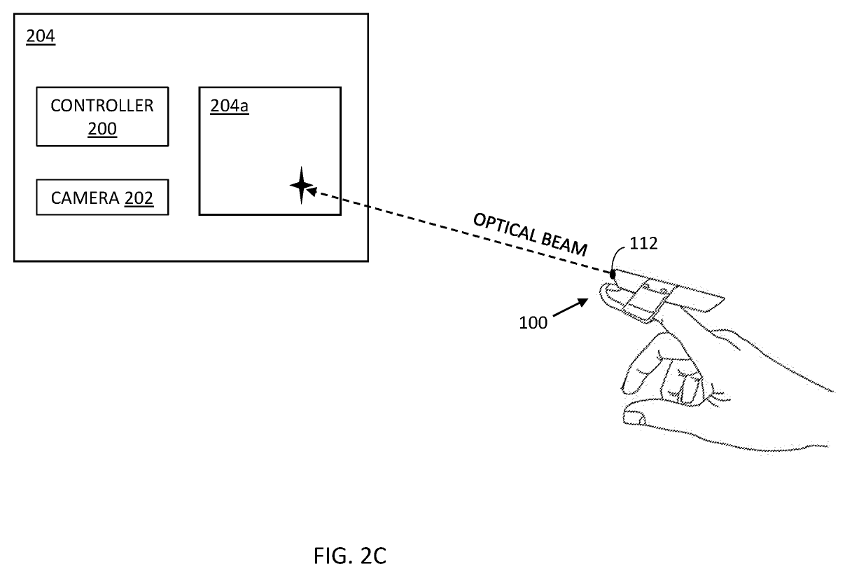

Reference is now made to FIG. 2A which shows a system for tracking a target indicated by hand held device 100, operable as a remote pointing device. The tracking may be based on any of optical and inertial data.

For illustrative purposes, the target is indicated in FIG. 2A as a four-cornered star displayed on a screen 204, and the optimal beam emitted by emitter 112 to indicate the target is indicated a light dashed line. Device 100 may be provided with a radio frequency (RF) transmitter (not shown) that communicates with a controller 200. The RF communication between device 100 and controller 200 is indicated for illustrative purposes as a light dashed line.

Responsive to activating device 100 in the remote use mode by sensing the user's thumb at sensor 114, processor of device 100 may trigger the tracking of the target, by transmitting via the RF transmitter to an RF receiver of a controller 200, a signal indicating to controller 200 to initiate the tracking of the target. The signal may be transmitted using any suitable transmission protocol, such as in accordance with any of a Wi-Fi, BlueTooth, Zigbee, or other RF protocol.

Responsive to receiving the signal, controller 200 may track the target optically using a camera 202. Camera 202 may capture a stream of images of the target (shown as a light dashed line) and provide the image stream to controller 200. In this remote mode of use, controller 200 tracks the target indicated by longitudinal emitter 112. Controller 200 may analyze the image stream using any suitable algorithms as are known in the art to track the spatial position of the target. Once the target is tracked, controller 200 may use additional signals received from device 100 to control the display of visual content on screen 202 in response to the additional signals.

Additionally, or alternatively, controller 200 may receive the motion and orientation data from device 100 via the RF receiver and may track the position of the target by calculating an estimation of the position using the motion and orientation data.

Additionally, the tracking may allow implementing functionalities responsive to recognizing one or more hand gestures by the user.

Optionally, controller 200 may display the visual content, depicted as a circle on screen 204, using a projector 206. The projected visual content is illustrated in FIG. 2A as two radiating dashed/dotted arrows enclosing a circle on screen 204. Additionally, or alternatively, screen 204 may be an electronic screen, such as a plasma or liquid crystal display (LCD) screen that renders the visual content displayed thereon. In this case, controller 200 may communicate directly with screen 204 to display the visual content thereon, accordingly.

In response to pressure sensing mechanism 118 sensing the second pressure, the processor of device 100 may send a command to controller 200 via the RF transmitter and RF receiver, to implement the location-based action corresponding to the tracked position of the moving target. In the example shown in FIG. 2A, the pressure may be exerted by the user pinching glider 102 firmly between his thumb and finger. Controller 200 may display visual content on screen 204 corresponding to the mouse click action, such as by implementing any of a select, highlight, move, rotate, open, close, zoom in, zoom out, render audio and/or multi-media content, to name a few. It may be appreciated this this list of actions is not meant to be limiting and any suitable location based action may be implemented accordingly.

Optionally, the RF transmitter of device 100 and the RF receiver of controller 200 may be transceivers, allowing controller 200 to send a notification to device 100. The processor of device 100 may use the notification to control one or more features, action, and/or functions of device 100, accordingly.

Any combination of controller 200, camera 202, screen 204 and projector 206 may be housed in a single unit, or alternatively, as shown in FIG. 2A, each unit may be a separate unit configured to communicate remotely with the other units, shown as dashed lines.

Referring to FIG. 2B, device 100 is shown used in the second operational mode in which device 100 is used as a contact pointer device pressed against surface 204. The point of contact between device 100 and surface 204 is indicated as a four-cornered star for illustrative purposes. Surface 204 may be an electronic display screen, or a passive screen such as a table top or wall.

Responsive to receiving an indication from pressure sensitive mechanism 118 sensing the first pressure level, the processor of device 100 may trigger the tracking of the target, by transmitting via the RF transmitter to an RF receiver of a controller 200, a signal indicating to controller 200 to initiate the tracking, as described above. The tracking may be optical or inertial based. When the tracking is optical based, in the current touch mode of use, camera 202 may capture a stream of images of the target indicated by surface-positioned emitter 116. Controller 200 may analyze the image stream as described above to spatially track the moving target. Similarly, controller 200 may optionally use the motion and orientation data received via the RF receiver to spatially track the moving target.

Responsive to receiving an indication from pressure sensitive mechanism 118 sensing the second pressure level, the processor of device 100 may trigger the location-based action corresponding to the location of the target indicated by emitter 116, and/or the motion and orientation data. The processor may transmit via the RF transmitter to an RF receiver of controller 200, a signal indicating to controller 200 to execute the location-based action corresponding to the tracked position of the moving target. For example, the target may be superimposed over displayed graphical content, and the location-based action may be executed as a mouse click that controls the displayed graphical content.

Referring to FIG. 2C, controller 200, camera 202, screen 204 are shown housed in one unit as an active screen 204. Camera 202 may be positioned to capture images of a display surface 204a of screen 204 to capture an images stream of a target indicated by device 100. For example, camera 202 may be positioned behind screen 204a or within a viewing range of screen 204a. Controller 200 may be housed in screen 204 and may use the image stream to render content accordingly, such as by displaying graphic content on display surface 204a, rendering audio on one or more speakers (not shown), render multi-media content, and the like. Display surface 204a may be an electronic display surface such as an LCD or plasma screen.

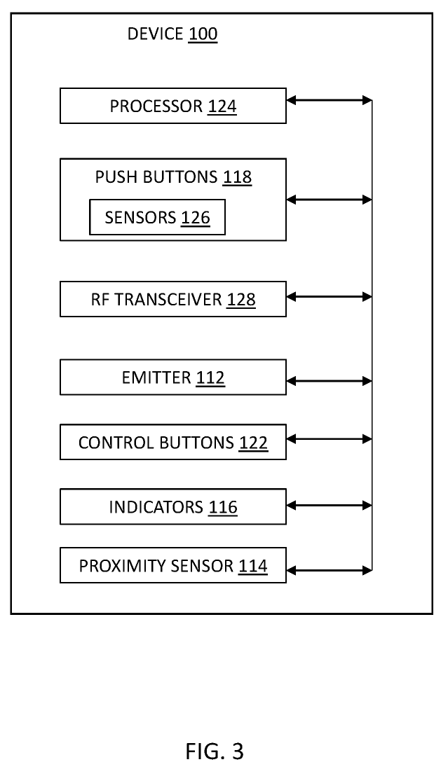

Reference is now made to FIG. 3 which shows a block diagram of hand held optical indicating device 100 having processor 124, pressure sensitive mechanisms 118 with sensor 126 implemented with glider 102 (not shown), RF transceiver 128, optical emitter 112, control buttons 122, optical emitters 116, and proximity sensor 114.

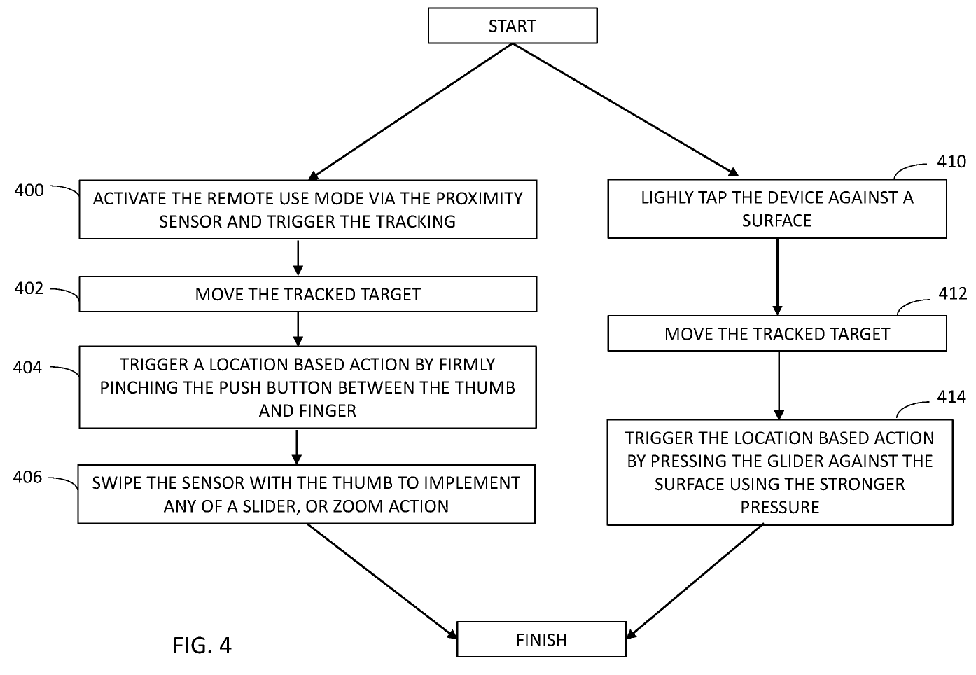

Reference is now made to FIG. 4, which shows a flowchart of a method for using the multisensory hand-held indicating device 100. When worn on a finger, the user may use device 100 as follows:
Option 1: activate remote use mode by touching or almost touching proximity sensor 114 to trigger tracking the target pointed at by device 100 (Step 400). Optical tracking is based on the optical beam emitted by emitter 112.
Move the target indicated by emitter 112 to the desired location by moving the location and/or orientation of the finger (Step 402).
Exert pressure (approximately 300 g) on the underside of device 100 by lightly pinching pressure sensitive mechanism 118 of glider 102 between the thumb and finger to trigger a location based action corresponding to the position of the tracked target (Step 404).
Swipe sensor 114 with the thumb to implement any of a slider, zoom-in, or zoom-out action (Step 406).
Option 2: lightly tap device 100 against a stiff and/or cold surface (apply approximately 50 g) to trigger tracking the target pointed at by device 100 (Step 410). Optical tracking is based on the optical beam emitted by surface emitter 116.
Move the position and/or orientation of device 100, thereby moving the target, to the desired location on the surface (Step 412).
Press glider 102 against the surface at the stronger pressure (approximately 300 g) to trigger a location based functionality corresponding to the tracked position of the (Step 414).

The following pseudo-code in an exemplary implementation of the method described above:

| | |
|---|---|
| while capacitiveSensor = 0 { | // Capacitive sensor does not detects thumb-to- |

finger pinch

| | |
|---|---|
| if pressureSensor = weak | // Pressure sensitive detects light pressure |

```
  (e.g. 50 grams)
    do initiateTracking( );
```

| | |
|---|---|
| if pressureSensor = strong | // Pressure sensitive detects stronger |

pressure (e.g. 300 grams)

| | |
|---|---|
| do sendClick( ); | // Send a click event to controller |
| else { | // Capacitive sensor detects thumb |

do initiateTracking( );

| | |
|---|---|
| do detectSwipe( ); | // Capacitive sensor detects region of strongest |

```
  capacitance
  if pressureSensor = strong
      do sendClick( ); // Send a click event to controller
  }
```

It may be appreciated that the description above is not meant to be limiting and the functionalities provided by the different modes of use activated alternately via the proximity sensor 114 or by pressing glider 102 against the surface may be the same or different.

Optionally, device 100 may operate with just a single pressure sensory level, or threshold. In this implementation, device 100 may operate in a manner substantially similar to that described above, with the noted difference that the processor may trigger the tracking for the remote use mode responsive to receiving an indication from the proximity sensor 114 only. Thus, merely touching or nearly touching sensor 114 may trigger the tracking for the remote use mode, regardless of any pressure applied, or not applied to pressure sensitive mechanism 118.

Similarly, for the touch mode, the processor may trigger the tracking responsive to receiving an indication from pressure sensitive mechanism 118 that a pressure level greater than or equal to the threshold, was detected. Thus, whether the user applies a high or low pressure to pressure sensitive mechanism 118, if the applied pressure is greater than the threshold, the tracking may be triggered.

The present invention may be a system, a method, and/or a computer program product. The computer program product may include a computer readable storage medium (or media) having computer readable program instructions thereon for causing a processor to carry out aspects of the present invention.

The computer readable storage medium can be a non-transitory, tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A multi-sensory finger-wearable pointing device, comprising:
at least one emitter;
a multi-sensory interface, comprising:
a proximity sensor, and
a pressure sensitive mechanism configured to sense a first pressure and a second pressure; and
a processor configured to:
a) responsive to receiving an indication from any of:
i) the proximity sensor, and
ii) the pressure sensitive mechanism that the first pressure was sensed,
trigger a tracking of a position of a moving target indicated by the pointing device, wherein the tracking is based on tracking information emitted by the at least one emitter, and
b) responsive to receiving an indication from the pressure sensitive mechanism that the second pressure was sensed, trigger a location based action corresponding to the tracked position of the moving target.

2. The finger-wearable pointing device of claim 1, wherein the at least one emitter comprises a radio-frequency (RF) emitter, wherein triggering the tracking comprises emitting a tracking notification via the RF emitter and wherein triggering the location based action comprises emitting an action notification via the RF emitter.

3. The finger-wearable pointing device of claim 2, wherein the RF transmitter is further configured to transmit the tracking information, wherein the tracking information comprises motion and orientation data of the device.

4. The finger-wearable pointing device of claim 1, wherein the at least one emitter comprises at least one optical emitter configured to emit an optical beam indicating the moving target, wherein the tracking information comprises the optical beam.

5. The finger-wearable pointing device of claim 4, wherein the at least one optical emitter comprises a longitudinal optical emitter aligned along a longitudinal axis of the device such that the optical beam emitted by the longitudinal optical emitter is substantially parallel to the longitudinal axis when the indication is received by the proximity sensor.

6. The finger-wearable pointing device of claim 4, wherein the at least one optical emitter comprises a surface optical emitter positioned on a surface of the device, when the indication that the first pressure was sensed is received from the pressure sensitive mechanism.

7. The finger-wearable pointing device of claim 1, wherein the proximity sensor is selected from the group consisting of: a capacitive sensor, an optical sensor, a resistive sensor, and a magnetic sensor.

8. The finger-wearable pointing device of claim 1, wherein the proximity sensor is operative to implement a slider action.

9. The finger-wearable pointing device of claim 1 wherein the second pressure level is greater than the first level.

10. The finger-wearable pointing device of claim 1, wherein triggering the position tracking of the moving target responsive to receiving the indication from the proximity sensor initiates a remote mode of use for the device, and wherein triggering the position tracking of the moving target responsive to receiving the indication from the pressure sensitive mechanism that the first pressure was sensed initiates a contact mode of use for the device.

11. The finger-wearable pointing device of claim 1, wherein the moving target is implemented as a cursor for controlling an application.

12. The finger-wearable pointing device of claim 11, wherein the location-based action is a click action for the cursor.

13. The finger-wearable pointing device of claim 1, further comprising a radio frequency (RF) receiver configured to receive a control signal, wherein the processor is configured to use the control signal to control the finger-wearable indicator.

14. A system comprising:
a multi-sensory finger-wearable pointing device, comprising:
at least one emitter,
a multi-sensory interface, comprising:
a proximity sensor, and
a pressure sensitive mechanism configured to sense a first pressure and second pressure, and
a processor configured to:
a) responsive to receiving an indication from any of:
i) the proximity sensor, and
ii) the pressure sensitive mechanism that the first pressure was sensed:
trigger a tracking of a position of a moving target indicated by the pointing device by transmitting a tracking notification via the at least one emitter, wherein the tracking is based on tracking information emitted by the at least one emitter, and
b) responsive to receiving an indication from the pressure sensitive mechanism that the second pressure was sensed, trigger a location based action corresponding to the tracked position of the moving target by transmitting an action notification via the at least one emitter;
a controller; and
at least one receiver,
wherein the controller is configured to, responsive to receiving the tracking notification via the at least one receiver, track the target using the tracking information received via the at least the receiver, and responsive to receiving the action notification, execute the location based action.

15. The system of claim 14, wherein the at least one emitter comprises a radio-frequency (RF) emitter configured to transmit each of the tracking notification and the action notification comprise as an RF signal, and wherein the at least one receiver comprises an RF receiver.

16. The system of claim 15, wherein the RF emitter is configured to transmit the tracking information comprising motion and orientation data as an RF signal.

17. The system of claim 14, wherein the at least one emitter comprises at least one optical emitter configured to emit an optical beam indicating the moving target, wherein the tracking information comprises the optical beam.

18. The system of claim 17, wherein the at least one optical emitter comprises a longitudinal optical emitter aligned along a longitudinal axis of the finger-wearable pointing device such that the optical beam emitted by the longitudinal optical emitter is substantially parallel to the longitudinal axis when the indication is received by the proximity sensor.

19. The system of claim 17, wherein the at least one optical emitter comprises a surface optical emitter positioned on a surface of the device, when the indication that the first pressure was sensed is received from the pressure sensitive mechanism.

20. The system of claim 14, wherein the proximity sensor is selected from the group consisting of: a capacitive sensor, an optical sensor, a resistive sensor, and a magnetic sensor.

21. The system of claim 14, wherein the proximity sensor is operative to implement a slider action.

22. The system of claim 14 wherein the second pressure level is greater than the first level.

23. The system of claim 14, wherein triggering the position tracking of the moving target responsive to receiving the indication from the proximity sensor initiates a remote mode of use for the device, and wherein triggering the position tracking of the moving target responsive to receiving the indication from the pressure sensitive mechanism that the first pressure was sensed initiates a contact mode of use for the device.

24. The system of claim 14, wherein the moving target is implemented as a cursor for controlling an application.

25. The system of claim 24, wherein the location based action is a click action for the cursor.

26. The system of claim 14, further comprising a radio frequency (RF) receiver configured to receive a control signal from the controller, wherein the processor is configured to use the control signal to control the finger-wearable indicator.

27. A multi-sensory finger-wearable pointing device, comprising:
at least one emitter;
a multi-sensory interface, comprising:
a proximity sensor, and
a pressure sensitive mechanism configured to sense a pressure; and
a processor configured to:
i. responsive to receiving an indication from the proximity sensor, trigger a tracking of a position of a moving target indicated by the pointing device, wherein the tracking is based on tracking information emitted by the at least one emitter, and
ii. responsive to receiving an indication from the pressure sensitive mechanism that the pressure was sensed, trigger a location based action corresponding to the tracked position of the moving target.
